(19) United States
(12) Patent Application Publication
(10) Pub. No.: US 2014/0101031 A1
(43) Pub. Date: Apr. 10, 2014

(54) Management of Contributions for a Goal

(71) Applicant: BANK OF AMERICA CORPORATION, Charlotte, NC (US)

(72) Inventors: Matthew A. Calman, Charlotte, NC (US); Carrie Anne Hanson, Charlotte, NC (US); John Rees, Charlotte, NC (US); Nancy Talarico, Matthews, NC (US); Greg Leonard Hertz, San Francisco, CA (US); Sven David Newman, Burlingame, CA (US)

(73) Assignee: Bank of America Corporation, Charlotte, NC (US)

(21) Appl. No.: 13/647,948

(22) Filed: Oct. 9, 2012

(51) Int. Cl. G06Q 20/22

(52) U.S. Cl. 705/39

(57) ABSTRACT

According to an embodiment, a contribution for a goal is managed. A monetary target associated with a goal is determined. A current savings level toward the monetary target is determined. A rule associated with a maximum contribution amount toward the monetary target is accessed. An amount for a contribution is calculated according to the monetary target, the current savings level, and the rule. The amount calculated for the contribution is transferred to an account associated with the goal.

### TECHNICAL FIELD OF THE INVENTION

This invention relates, in general, to goal management and, more particularly, to management of contributions for a goal.

### BACKGROUND OF THE INVENTION

The costs associated with purchasing certain items, such as college tuition or a car, can be significant. Furthermore, the costs of these items have continued to increase in recent times and may be difficult to estimate at some point in the future. Large costs may coincide with substantial delay before accumulation of enough funds to purchase the items. Additionally, individuals attempting to save for such items often do so in a haphazard manner.

### SUMMARY OF THE INVENTION

In accordance with the present invention, disadvantages and problems associated with management of goal contributions may be reduced or eliminated.

According to one embodiment of the present invention, a contribution for a goal is managed. A monetary target associated with a goal is determined. A current savings level toward the monetary target is determined. A rule associated with a maximum contribution amount toward the monetary target is accessed. An amount for a contribution is calculated according to the monetary target, the current savings level, and the rule. The amount calculated for the contribution is transferred to an account associated with the goal.

Certain embodiments of the invention may provide one or more technical advantages. A technical advantage of one embodiment allows automated management of contributions from one or more third-parties (e.g., transferors) to an account associated with a beneficiary's goal. The transferors' contributions may have various rules associated with when the contributions are made and the specific amount of the contributions. Rules associated with a maximum contribution amount may be automatically retrieved from any suitable source. For example, an older individual may be able to make regular fund transfers to a future heir. The maximum contribution amount may be set to the tax-free giving limit, such that fund transfers to the heir are maximized under any applicable tax codes. Another technical advantage of one embodiment allows for facilitated goal configuration through a graphical user interface. The transferors and the beneficiary may provide input on the configuration of the goal and the manner in which contributions are made. Another technical advantage of one embodiment allows for delivery of information related to the contributions through any suitable alerts and/or a graphical user interface. The transferors and/or the beneficiary may receive all information or information filtered in any suitable manner.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system operable to determine a contribution amount toward a goal.

FIG. 2 illustrates an example graphical user interface operable to facilitate configuration of a goal.

FIG. 3 illustrates an example graphical user interface operable to display progress toward a goal.

FIG. 4 illustrates an example flow chart for managing contributions toward a goal.

### DETAILED DESCRIPTION OF THE INVENTION

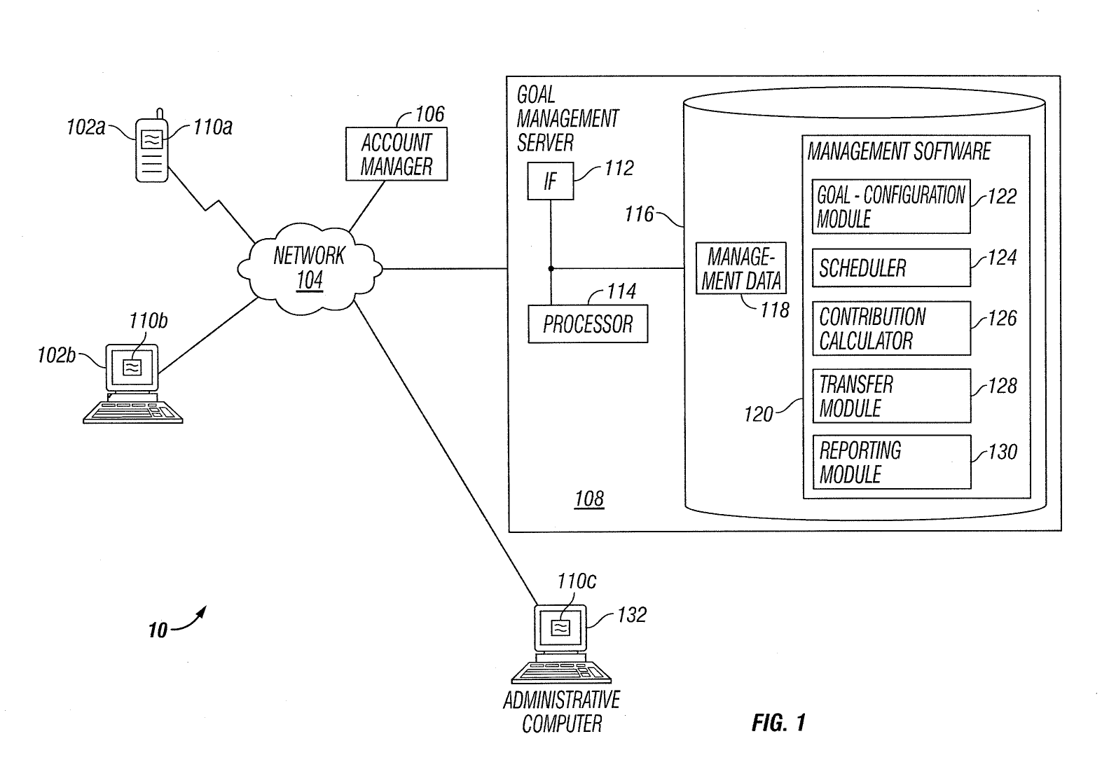

Embodiments of the present invention and its advantages are best understood by referring to FIGS. 1 through 4, like numerals being used for like and corresponding parts of the various drawings.

FIG. 1 illustrates an example system 10 operable to determine a contribution amount toward a goal. In particular embodiments, the goal may be an objective of a beneficiary of the contribution. For example, the goal may be to save enough money to purchase a house, take a vacation, pay for college tuition, pay for a car, save for a family reunion, or any other suitable goal. While the beneficiary attempts to save/gather enough money for the goal, another contributor, such as a parent or grandparent, may also contribute funds toward the goal in controlled amounts. System 10, for example, facilitates living giving from an older individual to a future heir on a regular basis. Sharing responsibility for determining gift amounts by both the older individual and the future heir for a specific goal may reduce the awkwardness sometimes associated with specifying the distribution of the older individual's estate. Additionally, gifting funds according to a schedule instead of distributing all funds at once from the individual's estate may also have tax benefits.

System 10 facilitates determination of the contribution amounts toward the goal, in some embodiments, by the transferor and/or the beneficiary. The addition of contributions of the transferor to those of the beneficiary may reduce the overall time necessary to build up enough funds to reach the goal. In other words, system 10 operates to accelerate dreams or goals of a beneficiary. System 10 may also allow the system users (e.g., transferor and/or beneficiary) to provide specific information about the goal, select certain conditions for any contributions, receive alerts related to savings contributions, monitor the progress toward the goal, and/or to perform any other suitable functions. Certain embodiments of system 10 include access devices 102 that communicate over network 104 with an account manager 106 and a goal management server 108.

Devices 102 may comprise any type of mobile or stationary computing device operable to facilitate configuration of a goal, monitor progress toward a goal, and/or provide any other suitable function. Examples of devices 102 include a mobile phone, personal digital assistant, laptop, netbook, ultrabook, tablet, desktop computer, cable box, television, automobile, and/or any other suitable device. Certain embodiments of system 10 include a device 102a that is a mobile phone, and a device 102b that is a desktop computer.

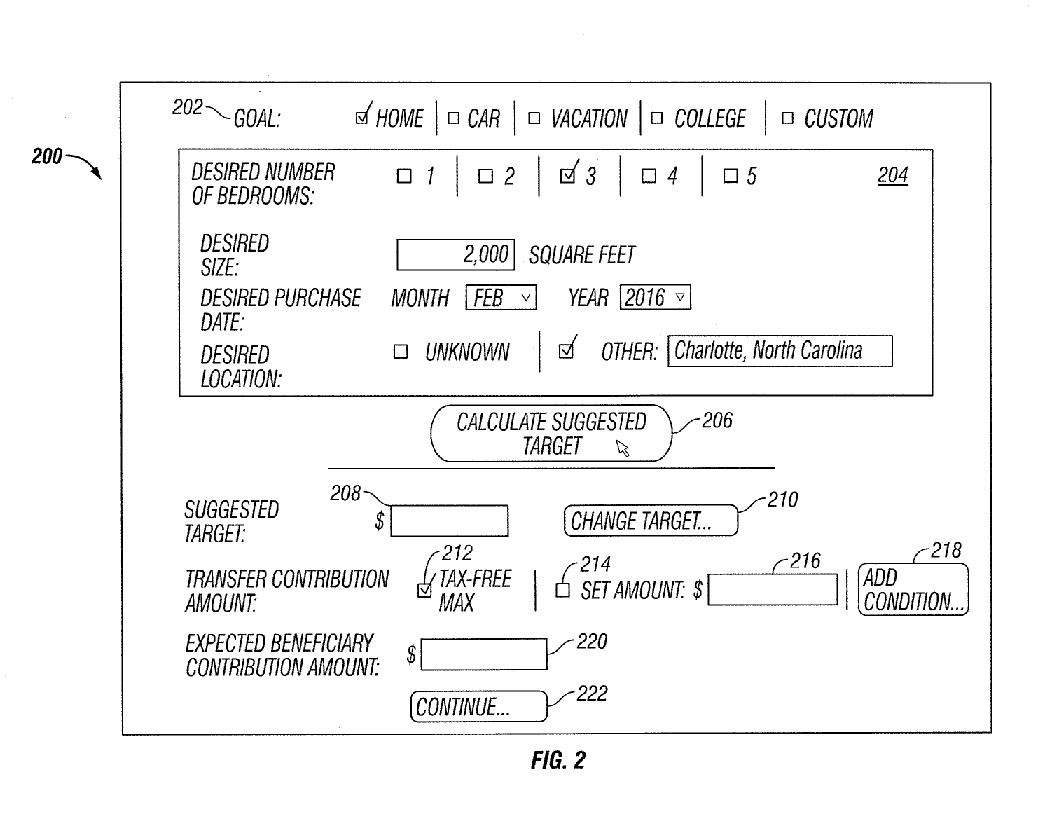

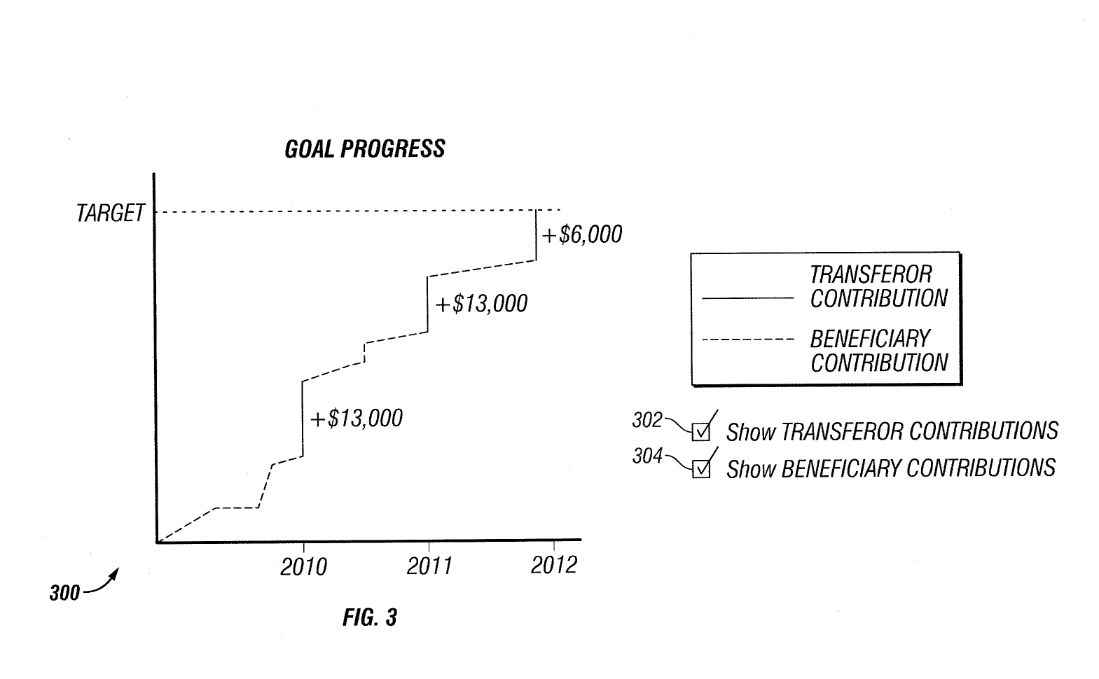

In certain embodiments, devices 102 include graphical user interfaces (“GUIs”) 110, which display information associated with a goal specified by a user of system 10. GUIs 110 are generally operable to tailor and filter data entered by and presented to the user. GUIs 110 may provide the user with an efficient and user-friendly presentation of information. For example, GUI 110b may comprise an interface that allows a user to enter selections associated with a goal. Based on certain selections by the user, GUI 110b may adapt automatically to provide a list of other choices to the user related to the goal. Certain GUIs 110 may comprise a plurality of displays having interactive fields, pull-down lists, and buttons operated by the user. GUIs 110 may include multiple levels of abstraction including groupings and boundaries. It should be understood that the term GUI may be used in the singular or in the plural to describe one or more GUIs and each of the displays of a particular GUI 110. Example GUIs 110 are described below with respect to FIGS. 2 and 3.

GUIs 110 may be displayed to a user using a web browser that allows a user of access devices 102 to interact with a website, communicatively coupled to goal management server 108 for example, by transmitting information to and receiving information from the website. Suitable web browsers may include Microsoft Internet Explorer®, Mozilla Firefox®, Google Chrome™, Apple Safari™, or Opera®. In certain embodiments, GUIs 110 may be displayed using an application natively installed on each of access devices 102. For example, an enterprise associated with goal management server 108 and/or account manger 108 may create and distribute a goal management application designed for mobile phone device 102a and another goal management application designed for computer 102b that both operate outside of a web browser. A user may install the goal management application on an access device and interact with the GUI provided by the goal management application to communicate with and instruct goal management server 108 to perform certain actions. In certain embodiments, GUIs 110 may be provided by a website or native application maintained by a third-party. In certain embodiments, the goal management applications form part of an application distributed by the administrator of the account to which contributions are made, such as a bank or other financial institution.

Network 104 represents any suitable network that facilitates communication between the components of system 10. Network 104 may include any interconnecting system capable of transmitting audio, video, signals, data, messages, or any combination of the preceding. Network 104 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

Account manager 106 includes any suitable combination of components that operate to manipulate, access, and/or report on an account. Account manager 106 may include the computing systems controlled by a financial institution, such as a bank, brokerage house, or investment firm. The accounts that account manager 106 controls may be any suitable account. For example, account manager 106 may have direct control over a checking account, a savings account, a brokerage account, a loan account, an investment account, a retirement account, an education savings account, and/or any other suitable account. In particular embodiments, account manager 106 may have direct control over an account associated with a goal. Such an account may be owned by a beneficiary of the contributions toward the goal. In some embodiments, account manager 106 may have direct control over an account from which contributions are made. Such an account may be owned by a party (or transferor) making contributions to the beneficiary's account. Account manager 106 allows, in certain embodiments, components such as devices 102 and goal management server 108 to access accounts that are under the control of account manager 106. Account manager 106 may ensure that components of system 10 that attempt to manipulate an account have the appropriate credentials, such as a username, password, account number, and/or any other suitable credential. Account manager 106 may include a non-transitory storage medium, hardware processor, and/or any components suitable to carry out actions in connection with user accounts.

Goal management server 108 is operable to facilitate management of user contributions toward a goal. Certain embodiments of goal management server 108 include functionality for obtaining/deriving information associated with a goal, scheduling contributions to an account associated with the goal, calculating suitable contribution amounts, delivering reports regarding goal progress, and/or any other suitable function.

Goal management server 108 may include a network server, any suitable remote server, a mainframe, a host computer, a workstation, a web server, a personal computer, a file, server, or any other suitable device operable to facilitate management of goal contributions. In some embodiments, goal management server 108 may execute any suitable operating system such as IBM's zSeries/Operating system (z/OS), MS-DOS, PC-DOS, MAC-OS, WINDOWS, UNIX, OPenVMS, Linux, iOS, Android, and/or any other appropriate operating systems, including operating systems developed in the future. The functions of goal management server 108 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In certain embodiments, goal management server 108 includes a network interface 112, a processor 114, and a memory 116.

Network interface 112 represents any suitable device operable to receive information from network 104, perform suitable processing of the information, communicate to other devices, or any combination of the preceding. For example, network interface 112 may receive selections associated with a goal from a user of device 102a via network 104. Network interface 112 represents any port or connection, real or virtual, including any suitable hardware and/or software, including protocol conversion and data processing capabilities, to communicate through a LAN, WAN, or other communication systems that allows goal management server 108 to exchange information with the other components of system 10.

Processor 114 communicatively couples to network interface 112 and memory 116. Processor 114 controls the operation and administration of goal management server 108 by processing information received from network interface 112 and memory 116. Processor 114 includes any hardware and/or software that operates to control and process information. For example, processor 114 executes management software 120 to control the operation of goal management server 108. Processor 114 may be a programmable logic device, a microcontroller, a microprocessor, any suitable processing device, or any suitable combination of the preceding.

Memory 116 stores, either permanently or temporarily, data, operational software, or other information for processor 114. Memory 116 includes any one or a combination of volatile or nonvolatile local or remote devices suitable for storing information. For example, memory 116 may include random access memory (RAM), read only memory (ROM), magnetic storage devices, optical storage devices, or any other suitable information storage device or a combination of these devices. While illustrated as including particular modules, memory 116 may include any suitable information for use in the operation of goal management server 108.

In certain embodiments, memory 116 includes management data 118 and management software 120. Management data 118 includes any rules used by management software 120 in carrying out its functions. For example, management data 118 includes selections provided by users of devices 102 for configuration of a particular goal. These may include rules associated with a contribution amount from a transferor to a beneficiary. As another example, management data 118 may also include rules indicating a limit on a tax-free gift. Rules in management data 118 may be updated from time-to-time by users of devices 102, administrative computer 132, and/or any other suitable device.

Management software 120 represents any suitable set of instructions, logic, or code embodied in a non-transitory, computer readable medium and operable to facilitate the operation of goal management server 108. Certain embodiments of management software 120 include a goal configuration module 122, a scheduler 124, a contribution calculator 126, a transfer module 128, and a reporting module 130.

Goal configuration module 122 is operable to facilitate configuration of a specified goal. The goal may be, for example, a goal shared by individual contributor and their future heir-beneficiary. Goal configuration module 122 determines the goal being pursued and associates that goal with a monetary target. The goal may be purchasing a home, saving for a vacation, paying college tuition, purchasing a car, saving for a family reunion, saving for retirement, saving funds generally, saving money for a third-party, or any other suitable goal. Goal configuration module 122 may associate a particular goal with a monetary target. For example, a particular monetary target may be linked to a specific goal in a look-up table stored in management data 118. Goal configuration module 122 may access such a table when determining the associated monetary target for the selected goal. The monetary target may be reached through monetary contributions provided by the beneficiary and/or any other transferors. Goal configuration module 122 may schedule transfer of contributions according to the specifications set by the beneficiary and/or the transferor.

In certain embodiments, goal configuration module 122 receives information regarding a goal from users of devices 102 via GUIs 110. For example, through the selections made on GUI 110, goal configuration module 122 may determine that the goal is to purchase a home at a specified date in the future. The selections provided through GUI 110 may also indicate an associated monetary target, or alternatively, goal configuration module 122 may determine an associated monetary target based on information accessed from management data 118. As stated above, a particular monetary target may be specified directly in management data 118 or goal configuration module 122 may instruct processor 114 to retrieve rules from management data 118 on which the monetary target may depend. For example, management data 118 may include historical house values, predicted changes in home prices, and any other suitable information to compute a predicted house value for a home to be purchased at a desired time. The associated monetary target may be the estimated purchase price of a home or a certain percentage of that estimated price, which may represent an estimated down payment for the purchase of a home.

Goal configuration module 122 may invoke a contribution calculator 126 to determine suitable contribution amounts. Contribution calculator 126 is operable to instruct processor 114 to calculate contributions in any suitable manner. For example, in some embodiments, the contributions from a transferor may be set to match the contributions made by the beneficiary during a specified time period, e.g., during one year. In another example, the transferor's contributions may be set to 50% of the contributions of the beneficiary in a specified time period. As another example, the contribution from a transferor may be set to be some percentage of income received on specified investment properties, such as a dividend. This could be based on all income received, income received on certain dates, income that exceeds a specified base amount, and/or by any other suitable measurement. Certain jurisdictions may specify that gifts in a particular range are not taxed while the amount of a gift beyond a specified limit would be subject to taxation. In such jurisdictions, the transferor's contributions may be set to equal the tax-free giving limit. In some instances, the users may be informed that a selected contribution amount would exceed a tax-free limit and given the choice of whether the limit should be exceeded.

Additionally, the contributions may be subject to any suitable conditions. For example, a transferor's contributions may be set to equal a certain amount A if the beneficiary made contributions equal to or exceeding a certain amount B. As another example, a transferor's contributions may be conditioned on the beneficiary maintaining a certain balance in the account over a certain time period or at a certain time, such as the end of the year.

Any of these examples (or any suitable combination) could be set as a maximum contribution amount for a contribution of a transferor. For example, the maximum contribution amount for the transferor could be set to the amount contributed by the beneficiary. As another example, the maximum contribution amount may be set to either the amount contributed by the beneficiary or the limit on tax-free gifts, whichever value is lower. In either example, the actual contribution amount may be lower than the maximum contribution amount. For example, the account from which the transferor's contributions are drawn may not contain enough funds to cover the maximum contribution amount. As another example, the difference between the monetary target and the total amount currently saved may be lower than the maximum contribution amount. In such embodiments, the actual contribution may equal the difference between the monetary target and the total amount saved. To determine the amount of funds in either the account associated with the goal or the account set to make the contribution, contribution calculator 126 may instruct processor 114 and/or network interface 112 to communicate with account manger 106. Appropriate access credentials may be supplied by the account owners during the goal set-up phase and stored in management data 118.

Contribution calculator 126 may determine the monetary target and/or the maximum contribution amounts by accessing rules from management data 118. For example, management data 118 may include preferences for contributions specified by a transferor and/or a beneficiary of the contributions via a device 102. As another example, management data 118 may include information that specifies a limit on tax-free giving. These rules may be updated from time-to-time, such that a maximum contribution amount may change after the initial goal was determined and before the monetary target is reached.

Goal configuration module 122 may invoke a scheduler 124 to schedule events associated with contributions provided by the transferor and/or the beneficiary. For example, a scheduler 124 may schedule contributions monthly, twice a year, yearly, or at any other suitable time. Where appropriate, scheduler 124 spreads the maximum contribution amount according to the time periods in which contributions are being made. For example, scheduler 124 may schedule and calculate monthly contributions such that their sum for a year does not exceed the annual tax-free gift limit. In certain embodiments, scheduler 124 may schedule contributions from the transferor on the beneficiary's birthday or on a certain holiday. In such embodiments, the beneficiary and/or transferor may receive an alert (e.g., an e-mail or written letter) indicating that a contribution has been made. Additionally, scheduler 124 may estimate the date on which a monetary target will be reached. This information may be communicated to users via devices 102 during goal set-up and/or while contributions toward the goal are being made.

Transfer module 128 is operable to facilitate transfer of contributions to an account associated with the goal. For example, when scheduler 124 indicates that a contribution should be made, transfer module 128 may include instructions for processer 114 to automatically alert a user to make the contribution through an electronic mail, by producing a written letter and sending the letter to the appropriate user, and/or in any other suitable manner. As another example, transfer module 128 may instruct processer 114 and/or network interface 112 to communicate with one or more account managers 108 to transfer a contribution from the transferor's account to an account associated with the goal.

Reporting module 130 is operable to facilitate delivery of information associated with any contributions made to an account associated with the goal. For example, reporting module 130 may alert the beneficiary of the account when a transfer of a contribution is made to the account. As noted above, this alert may be delivered at any suitable time, such as the beneficiary's birthday and/or on a holiday. The alert does not have to coincide with a contribution, but may be set to provide a snapshot of progress toward the goal at any given point in time.

Reporting module 130 may also instruct processor 114 to provide information regarding the current progress to devices 102 for delivery to users of those devices via GUIs 110. The information may be provided to the user in any suitable format, such as a graph displaying the amount contained in the goal account over a specified time period. A graphic format may be able to visually distinguish among contributions made from different sources. For example, by viewing a progress display, a user may be able to visually discern the contributions made by a transferor, those may be the beneficiary, and those from interest income deposited into the account associated with the goal.

In particular embodiments, certain users may be limited to viewing only a subset of the information related to contributions made to the account associated with the goal. For example, where a transferor's contributions are conditioned on the beneficiary's savings habits, reporting module 130 may instruct processor 114 and/or network interface 112 to send to the device 120 operated by the transferor confirmation only that such conditions have been met. To illustrate this, suppose that a transferor pledges $1000 to the goal account if the beneficiary saves $2000 in a year. If the beneficiary actually contributes $3000 to the goal account, the transferor may only receive confirmation that the beneficiary met the condition and not how much the beneficiary exceeded the condition amount.

Administrative computer 132 represents any suitable components that facilitate establishment and/or modification of the configuration of any of the components of goal management server 108 through network 104. An administrator may use administrative computer 132 to update the rules in management data 118 that indicate, for example, the conditions and/or configurations for contributions to an account associated with a goal. For example, in response to a change in the tax code, an administrator may update a rule in management data 118 that indicates the tax-free giving limit. As another example, administrative computer 132 may include software that monitors the tax code and automatically updates rules in management data 118 in response.

In certain embodiments, administrative computer 132 may facilitate set up or modifications to the goal management process. For example, administrative computer 132 may be situated at a financial institution, such as a bank. The potential contributors to a goal-based account, such as an older individual and a future heir, may come to the bank and initiate the goal management process with the help of an administrator at the bank using administrative computer 132. As another example, one or more potential contributors may telephone an administrator using administrative computer 132 to set up the goal management process. In a similar fashion, administrative computer 132 may be used to make changes to a goal management process, such as changing the monetary target in response to modified goal (e.g., a bigger/smaller house). Administrative computer 132 may include a GUI 110c to facilitate configuration of the goal with goal management server 108.

Administrative computer 132 may comprise a network server, any suitable remote server, a mainframe, a host computer, a workstation, a web server, a personal computer, a file, server, or any other suitable device operable to configure the components and rules used by account manager 106 and/or goal management server 108. In some embodiments, administrative computer 132 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of administrative computer 132 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In an exemplary embodiment of operation of system 10, a grandparent uses system 10 to make living gifts to her future heir, her grandchild. The grandparent and grandchild decide on a goal of purchasing a car for the grandchild. Both will make monetary contributions toward the goal, which will be held in an account set up to hold savings for the car. The grandparent and grandchild use GUI 110b on device 102b to configure the goal. When a purchase of a car is selected as the goal, GUI 110b automatically adapts to acquire additional information about the car being purchased. GUI 110b asks for the type of car, model of the car, any special options on the car, and the desired date of purchase. These selections are communicated to goal management server 108, which uses the selections to determine a monetary target associated with the goal. The monetary target is communicated back to GUI 110b, where the grandparent and grandchild are given the choice to customize the target.

GUI 110b asks for estimated contributions for each of the grandparent and grandchild. The grandparent will make annual contributions to the account on the grandchild's birthday from one of the grandparent's accounts. The grandparent's contributions will match the annual contributions of the grandchild. The grandparent is notified by GUI 110b that matches to the grandchild's contribution may be subject to taxation if the grandparent's contribution exceeds the tax-free giving limit. The grandparent and grandchild then determine that the grandparent's annual contribution should not exceed the tax-free giving limit. These selections are communicated to the goal management server 108 and stored in management data 118.

Goal management server 106 operates to determine the current savings level of the account associated with the goal annually on the child's birthday by communicating with account manager 106. Goal management server 106 then calculates the grandparent's contribution in light of the amount contributed by the grandchild for the past year, the total amount saved, and the tax-free giving limit. Goal management server 106 then facilitates the transfer of the contribution from the grandparent's account to the account associated with the goal. Goal management server 106 then sends a communication to devices operated by the grandparent and/or grandchild alerting them of the transfer. The grandparent and/or grandchild use GUIs on devices 102 to monitor overall progress and to modify the goal after goal set-up process has been initiated. The components of system 10 may allow the grandparent to make regular contributions to the goal account while providing maximum benefits under the provisions of a tax code.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, GUIs 110 may manage multiple goals for one or more beneficiaries. In such a case, a grandparent, for example, may be able to manage contributions to goals for several different grandchildren (i.e., several future heirs). Additionally, there may be multiple beneficiaries for the same goal (e.g., an aggregated retirement account for several children). The components may be integrated or separated. For example, the functionality of goal management server 108 may reside in access devices 102, account manager 106, and/or administrative computer 132.

FIG. 2 illustrates an example GUI 200 operable to facilitate configuration of a goal. In certain embodiments, GUI 200 may be a part of GUI 110 of FIG. 1. GUI 200 displays choices associated with a goal to a user, allows the user to make certain selections, and communicates selections to a suitable destination, such as goal management server 108. GUI 200 is operable to change a portion of the options presented to a user in response to one or more selections made by the user, such that the goal configuration process may appear to the user as a guided interaction through a goal set-up wizard. In one example, an older individual and a future heir-beneficiary may use GUI 200 together to set up a goal. In other words, GUI 200 facilitates a conversation between the older individual to the heir regarding scheduled transfers of funds to the heir. The results of such a conversation may be input into GUI 200.

GUI 200 provides the user with a choice of a goal 202. The user may choose from a list of predetermined goals and/or customize their own goal. In certain embodiments, goal 202 is presented as a list including HOME, CAR, VACATION, COLLEGE, and CUSTOM. Respectively, these represent goals of purchasing a home, purchasing a car, saving for a vacation, saving for college expenses, and configuring a custom goal. Upon selection of one or more of these selections, GUI 200 presents the user with more choices in goal details pane 204.

Goal details pane 204 is operable to display suitable choices to a user based upon their selection of goal 202. For example, when a user selects goal 202 to be HOME, goal details pane 204 displays further choices to the user to help the user further define the goal of purchasing a home. These choices may include a desired number of bedrooms, a desired size, a desired purchase date, and any other suitable choice. These selections may be used in determining a suitable monetary target. As another example, when a user selects goal 202 to be CUSTOM, goals detail pane 204 may allow the user to directly provide a desired monetary target and a desired date for which the target will be reached.

Once suitable selections have been made, a monetary target is calculated when the user depresses a calculate button 206. The monetary target may be determined by communicating with a backend goal management server, by using computing functions on the device on which GUI 200 resides, and/or by any other suitable method. The determined monetary target appears in suggested target box 208. The user may change the amount that will be used as the monetary target by depressing a change target button 210.

GUI 200 also provides many choices for the transferor's contributions. These contributions may be limited to the tax-free maximum gift limit by selecting checkbox 212. Additionally, the transferor may specify a set contribution amount by selecting checkbox 214 and entering an amount into box 216. If checkbox 212 is not selected and the set contribution amount exceeds a tax-free giving limit, a notice may pop-up on GUI 200 alerting the user that the selected amount exceeds the tax-free giving limit. Upon notice, the user may then choose to reduce the selected contribution amount. Any suitable conditions may be added to the transferor's conditions by depressing add condition button 218 and entering desired conditions on the transferor's contributions. Certain embodiments of GUI 200 may provide an option for selecting the frequency of the transferor's contributions (e.g., monthly, yearly, birthdays, holidays, etc.).

Additionally, GUI 200 displays information associated with the beneficiary's contributions. In certain embodiments, box 220 may allow a user to enter the amount that the beneficiary expects to contribute. In alternative embodiments, the expected contributions of the contribution may be calculated based on the determined monetary target and the transferor's contributions. For example, this may be calculated as the difference between the monetary target and the transferor's contributions. This amount may be displayed in box 220. In some embodiments, GUI 200 displays the periodic contribution (e.g., monthly, yearly, etc.) of the beneficiary. The users may continue to specify any other suitable selections associated with the goal by depressing the continue button 222 on GUI 200.

Modifications, additions, or omissions may be made to GUI 200 without departing from the scope of the invention. For example, GUI 200 may allow a user to choose which accounts contributions are received from and which accounts contributions are transferred to. Additionally, GUI 200 may allow selection of multiple goals 202. In such an embodiment, goal details pane 204 may include choices for all selected goals and components 208 through 222 may show an aggregate for all goals and/or may show multiple other boxes/selector corresponding to all goals selected.

FIG. 3 illustrates an example GUI 300 operable to display progress toward a goal. In certain embodiments, GUI 300 may be a part of GUI 110 of FIG. 1. GUI 300 may include checkboxes 302 and 304. When checkbox 302 is selected, GUI 300 displays the transferor's contributions. When checkbox 304 is selected, GUI 300 displays the beneficiary's contributions. In certain embodiments, one of checkbox 302 and checkbox 304 may be disabled to disallow a user (e.g., beneficiary and/or transferor) from seeing contributions from another user. In particular embodiments, such as that shown in GUI 300, the beneficiary's contributions are made generally at any time while the transferor's contributions are made annually. In this example, the transferor's contributions are capped at $13,000. This amount may be equal to a tax-free giving limit, such that gifting from an older individual to a future heir is maximized under the applicable tax code. At the end of 2012, the transferor's contributions are less than the maximum because the difference between the monetary target and the amount of savings at that time is less than the maximum contribution of $13,000.

Modifications, additions, or omissions may be made to GUI 300 without departing from the scope of the invention. For example, GUI 300 may show separate trend lines for each contribution and/or one trend line for the total of all contributions. As another example, where appropriate, GUI 300 may display contributions from any other sources, such as from interest earned in the account that contains the contributions toward the goal.

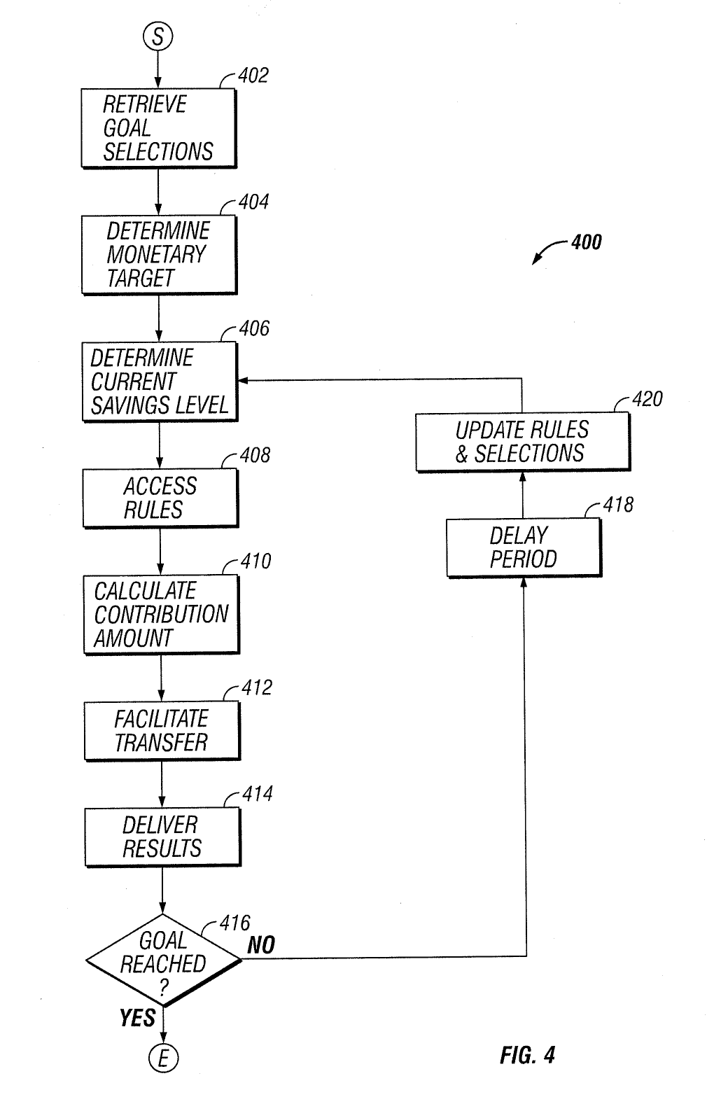

FIG. 4 illustrates an example method 400 for managing a contribution toward a goal. The method begins at step 402, where goal selections are retrieved. The goal selections may be received from a GUI such as GUI 110 on a computing device. At step 404, a monetary target associated with the goal is determined. In certain embodiments, the monetary target may be determined according to one or more selections provided via a GUI such as GUI 110. At step 406, a current savings level is determined. The current savings level may be determined, for example, by accessing an account associated with the goal. At step 408, a rule associated with a maximum contribution amount toward the monetary target is accessed. The rule may specify a tax-free giving limit, a percentage of another user's contributions during a specified time period, conditions specified for the contribution, any another suitable criteria, and/or any suitable combination of the preceding.

A contribution is calculated at step 410. The contribution calculated may be based on the rule accessed in step 408. The maximum contribution may also be determined based on the rule. The monetary target deficit may be calculated as the difference between the monetary target and the current savings level determined in step 406. In certain embodiments, the contribution amount is determined to be the lower of the monetary target deficit and the maximum contribution amount. In some embodiments, conditions are checked for the contribution. If the particular conditions have not been met, a contribution may not be made for the goal during a specified time period.

At step 412, a transfer of funds equal to the contribution determined in step 410 is facilitated. The transfer may be facilitated by, for example, communicating a notice to the appropriate contributor, communicating with an account manager to facilitate transfer of the funds between suitable accounts automatically without intervention from the contributor, and/or in any other suitable manner. At step 414, information associated with the contribution is delivered. This may occur by communicating an alert sent to any suitable user, communicating progress toward the goal to a device for display on a GUI, and/or in any other suitable manner. Step 416 determines whether the monetary target associated with the goal has been reached. If so, the method ends.

If the goal has not been reached, the method continues to step 418. At step 418, the method waits for a specified amount, such as the amount of time chosen for the frequency of a certain user's contributions. At step 420, the rules and selections associated with the goal may be updated. For example, a rule may be changed if the tax-free giving limit has been changed from a previous time period and/or if the transferor's maximum contribution amount changes. The method then returns to step 406, where the current savings level is determined again.

Modifications, additions, or omissions may be made to method 400 disclosed herein without departing from the scope of the invention. The methods may include more, fewer, or other steps. For example, method 400 may include steps for managing contributions by any user to a second goal. Additionally, steps may be performed in parallel or in any suitable order.

Certain embodiments of the invention may provide one or more technical advantages. A technical advantage of one embodiment allows automated management of contributions from one or more third-parties (e.g., transferors) to an account associated with a beneficiary's goal. The transferors' contributions may have various rules associated with when the contributions are made and the specific amount of the contributions. Rules associated with a maximum contribution amount may be automatically retrieved from any suitable source. For example, an older individual may be able to make regular fund transfers to a future heir. The maximum contribution amount may be set to the tax-free giving limit, such that fund transfers to the heir are maximized under any applicable tax codes. Another technical advantage of one embodiment allows for facilitated goal configuration through a graphical user interface. The transferors and the beneficiary may provide input on the configuration of the goal and the manner in which contributions are made. Another technical advantage of one embodiment allows for delivery of information related to the contributions through any suitable alerts and/or a graphical user interface. The transferors and/or the beneficiary may receive all information or information filtered in any suitable manner.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A server for managing a contribution for a goal, comprising:
a memory comprising a rule associated with a maximum contribution amount toward a monetary target; and
a processor communicatively coupled to the memory and operable to:
determine the monetary target associated with a goal shared between a non-employer contributor and a beneficiary;
determine a current savings level toward the monetary target;
access the rule associated with the maximum contribution amount toward the monetary target by the non-employer contributor;
determine that a condition agreed upon by the non-employer contributor and the beneficiary associated with a beneficiary contribution contributed to an account associated with the goal during a specified time period has been satisfied, wherein the specified time period is after a first contribution to the account associated with the goal;
calculate an amount for a contribution by the non-employer contributor during the specified time period according to the monetary target, the current savings level, the condition agreed upon by the non-employer contributor and the beneficiary, and the rule, wherein the calculation of the contribution by the non-employer contributor occurs dynamically during the specified time period and after transferring the first contribution to the account associated with the goal and without user interaction;
facilitate transfer of the amount calculated for the contribution by the non-employer contributor during the specified time period to the account associated with the goal; and
present the contribution made by the non-employer contributor during the specified time period on a graphical user interface operable to selectively display any contributions to the account associated with the goal according to contributing source.

2. The server of claim 1, wherein the processor is further operable to:
determine the maximum contribution amount according to the rule;
calculate a monetary target deficit as a difference between the monetary target and the current savings level; and
determine the amount for the contribution as a minimum value of a group comprising the maximum contribution amount and the monetary target deficit, wherein the determination of the contribution occurs dynamically after transferring the first contribution to the account associated with the goal and without user interaction.

3. The server of claim 1, wherein the processor is further operable to calculate the maximum contribution amount according to a tax-free transfer limit.

4. The server of claim 1, wherein the processor is further operable to facilitate updating the rule such that the maximum contribution amount differs from a previous maximum contribution amount.

5. The server of claim 1, wherein the rule further indicates that the amount for the contribution for the specified time period is determined according to a second contribution to the account associated with the goal, wherein the second contribution is transferred to the account associated with the goal during the specified time period, wherein the contribution and the second contribution are provided by different sources.

6. The server of claim 1, wherein the processor is further operable to determine an amount for a second contribution associated with a second goal.

7. The server of claim 1, wherein the processor is further operable to determine information associated with the goal from a selection received by the graphical user interface.

8. The server of claim 1, wherein the processer is further operable to facilitate delivery of information associated with the contribution made to the account associated with the goal.

9. A method for managing a contribution for a goal, comprising:
determining a monetary target associated with a goal shared between a non-employer contributor and a beneficiary;
determining a current savings level toward the monetary target;
accessing a rule associated with a maximum contribution amount toward the monetary target by the non-employer contributor;
determining that a condition a reed upon by the non-employer contributor and the beneficiary associated with a beneficiary contribution contributed to an account associated with the goal during a specified time period has been satisfied, wherein the specified time period is after a first contribution to the account associated with the foal;
calculating, using a processor, an amount for a contribution by the non-employer contributor during the specified time period according to the monetary target, the current savings level, the condition agreed upon by the non-employer contributor and the beneficiary, and the rule, wherein the calculation of the contribution by the non-employer contributor occurs dynamically during the specified time period and after transferring the first contribution to the account associated with the goal and without user interaction;
facilitating transfer of the amount calculated for the contribution by the non-employer contributor during the specified time period to the account associated with the goal; and
presenting the contribution made by the non-employer contributor during the specified time period on a graphical user interface operable to selectively display any contributions to the account associated with the goal according to contributing source.

10. The method of claim 9, further comprising:
determining the maximum contribution amount according to the rule;
calculating a monetary target deficit as a difference between the monetary target and the current savings level; and
determining the amount for the contribution as a minimum of a group comprising the maximum contribution amount and the monetary target deficit, wherein the determination of the contribution occurs dynamically after transferring the first contribution to the account associated with the goal and without user interaction.

11. The method of claim 9, wherein the maximum contribution amount is determined according to a tax-free transfer limit.

12. The method of claim 9, wherein the rule is updated such that the maximum contribution amount is different from a previous maximum contribution amount.

13. The method of claim 9, wherein the rule further indicates that the amount for the contribution for the specified time period is determined according to a second contribution to the account associated with the goal, wherein the second contribution is transferred to the account associated with the goal during the specified time period, wherein the contribution and the second contribution are provided by different sources.

14. The method of claim 9, further comprising determining an amount for a second contribution associated with a second goal.

15. The method of claim 9, further comprising determining information associated with the goal from a selection received by the graphical user interface.

16. The method of claim 9, further comprising facilitating delivery of information associated with the contribution made to the account associated with the goal.

17. A non-transitory computer readable medium comprising logic, the logic when executed by a processor, operable to:
determine a monetary target associated with a goal shared between a non-employer contributor and a beneficiary;
determine a current savings level toward the monetary target by the non-employer contributor;
access a rule associated with a maximum contribution amount toward the monetary target by the non-employer contributor;
determine that a condition agreed upon by the non-employer contributor and the beneficiary associated with a beneficiary contribution contributed to an account associated with the goal during a specified time period has been satisfied, wherein the specified time period is after a first contribution to the account associated with the goal;
calculate an amount for a contribution by the non-employer contributor during the specified time period according to the monetary target, the current savings level, the condition agreed upon by the non-employer contributor and the beneficiary, and the rule, wherein the calculation of the contribution by the non-employer contributor occurs dynamically during the specified time period and after transferring the first contribution to the account associated with the goal and without user interaction;
facilitate transfer of the amount calculated for the contribution by the non-employer contributor during the specified time period to the account associated with the goal; and
present the contribution made by the non-employer contributor during the specified time period on a graphical user interface operable to selectively display any contributions to the account associated with the goal according to contributing source.

18. The computer readable medium of claim 17, wherein the logic is further operable to:
determine the maximum contribution amount according to the rule;
calculate a monetary target deficit as a difference between the monetary target and the current savings level; and
determine the amount for the contribution as a minimum value of a group comprising the maximum contribution amount and the monetary target deficit, wherein the determination of the contribution occurs dynamically after transferring the first contribution to the account associated with the goal and without user interaction.

19. The computer readable medium of claim 17, wherein the logic is further operable to calculate the maximum contribution amount according to a tax-free transfer limit.

20. The computer readable medium of claim 17, wherein the rule further indicates that the amount for the contribution for the specified time period is determined according to a second contribution to the account associated with the goal, wherein the second contribution is transferred to the account associated with the goal during the specified time period, wherein the contribution and the second contribution are provided by different sources.

21. The computer readable medium of claim 17, wherein the logic is further operable to determine information associated with the goal from a selection received by the graphical user interface.

22. The computer readable medium of claim 17, wherein the logic is further operable to facilitate delivery of information associated with the contribution made to the account associated with the goal.
